(19) United States
(12) Patent Application Publication
(10) Pub. No.: US 2012/0242626 A1
(43) Pub. Date: Sep. 27, 2012

(54) ELECTRONIC WATCH CAPABLE OF ADJUSTING DISPLAY ANGLE OF SCREEN CONTENT THEREOF

(75) Inventor: Wei-Han Hu, Taipei City (TW)

(73) Assignee: MITAC INTERNATIONAL CORP., Taoyuan County (TW)

(21) Appl. No.: 13/416,631

(22) Filed: Mar. 9, 2012

(30) Foreign Application Priority Data
Mar. 21, 2011 (TW) 100109530

(51) Int. Cl. G09G 5/00

(52) U.S. Cl. 345/184; 345/156

(57) ABSTRACT

An electronic watch includes an input interface, a processor, and a display interface. The input interface receives an input and generates a setting command that corresponds to the input. The processor is operable to generate screen content, to determine a display angle corresponding to the setting command, and to rotate the screen content according to the display angle. The display interface is operable to display the screen content received from the processor in a manner that the screen content is rotated relative to the display interface by the display angle.

### CROSS-REFERENCE TO RELATED APPLICATION

This application claims priority of Taiwanese Application No. 100109530, filed on Mar. 21, 2011.

### BACKGROUND OF THE INVENTION

1. Field of the Invention

The invention relates to an electronic watch, and more particularly to an electronic watch capable of adjusting display angle of screen content thereof.

2. Description of the Related Art

A display of a conventional sporting electronic watch uses a fixed special angle design, such as downwardly inclined at a 45° angle or upwardly inclined at a 45° angle, to suit users who prefer wearing their watches on the left wrist or the right wrist. Moreover, a conventional portable music player is able to detect angle of hand/arm movement of the user and to rotate automatically screen content on a display by a 90° angle according to the detected angle.

In the design of the aforementioned sporting electronic watch, the display is fixed at a preset angle that cannot be adjusted by the user. In the design of the aforementioned portable music player, rotation of screen content on the display is limited to a number of specific directions, such as automatic rotation by 90° upward or automatic rotation by 90° downward. Users are unable to adjust the viewing angle as desired, thereby resulting in low flexibility in use.

### SUMMARY OF THE INVENTION

Therefore, an object of the present invention is to provide an electronic watch that allows a user to adjust display angle of screen content thereof for enhancing flexibility in use.

According to the present invention, an electronic watch includes an input interface, a processor, and a display interface.

The input interface is for receiving an input and generating a setting command that corresponds to the input. The processor is coupled electrically to the input interface and is operable to generate screen content, to determine a display angle corresponding to the setting command, and to rotate the screen content according to the display angle thus determined. The display interface is coupled electrically to the processor and is operable to display the screen content received from the processor in a manner that the screen content is rotated relative to the display interface by the display angle. After the display of the screen content rotated according to the display angle, the display of the screen content is maintained with the display angle until the processor determines a new display angle corresponding to a new setting command received from the input interface.

Preferably, the display angle ranges from 5° to 45°, and the display angle is one of 45°, 30°, 25°, 20°, 10°, and 5°.

Preferably, the input interface includes a rotary knob. The rotary knob has a rotation axis that is transverse to a display plane of the display interface. When the rotary knob is rotated by a first angle in a first direction, the input interface generates the setting command corresponding to rotation of the rotary knob, and the processor rotates the screen content in the first direction according to the display angle corresponding to the setting command. When the rotary knob is rotated by a second angle in a second direction opposite to the first direction, the input interface generates the setting command corresponding to rotation of the rotary knob, and the processor rotates the screen content in the second direction according to the display angle corresponding to the setting command.

Preferably, the rotary knob is formed with a plurality of graduations. Rotation of the rotary knob by one graduation in either of the first and second directions results in the processor rotating the screen content in the corresponding one of the first and second directions by a unit angle corresponding to one graduation.

Preferably, the unit angle is one of 45°, 30°, 25°, 20°, 10°, and 5°.

Preferably, the electronic watch further comprises a storage unit for storing a look-up table that defines relations between the setting command and the display angle. The processor is coupled electrically to the storage unit and accesses the storage unit to determine the display angle that corresponds to the setting command received from the input interface.

Preferably, the processor is operable under an angle setting mode in which the processor controls the display interface to display a display angle menu thereon. The display angle menu contains a plurality of display angle options available for user selection. The input interface includes at least one select button that is user operable to select one of the display angle options shown on the display interface when the processor is operated under the angle setting mode and to generate the setting command that corresponds to the selected one of the display angle options. The processor accesses the storage unit to determine from the look-up table the display angle that corresponds to the setting command received from the input interface and to rotate the screen content according to the display angle thus determined.

Preferably, the processor is operable under an angle setting mode, in which the processor controls the display interface to display a virtual rotary knob thereon. The input interface includes a transparent touch panel that is disposed on the display interface and that is operable to detect a gesture acting thereon. The processor recognizes the setting command corresponding to the gesture action that is detected at the position of the virtual rotary knob displayed by the display interface. Display of the screen content is rotated according to the display angle and is maintained with the display angle that is adjusted after the processor ceases to operate under the angle setting mode.

Preferably, the processor is operable under an angle setting mode. The input interface includes a transparent touch panel that is disposed on the display interface and that is operable to detect a gesture action thereon. The processor recognizes the setting command corresponding to the gesture action on the transparent touch panel. Display of the screen content is rotated according to the display angle and is maintained with the last display angle after the processor ceases to operate under the angle setting mode. Preferably, the processor is further operable to adjust at least one of character display position and character size of the screen content according to the display angle such that the screen content adjusted by the processor is displayed at a central area of a display plane of the display interface.

The electronic watch of the present invention allows a user to select a display angle of screen content through an input interface, and a processor of the electronic watch rotates the screen content according to a setting command from the input interface so that, when the screen content is displayed by a display interface, the screen content is rotated relative to the display interface by the display angle selected by the user.

### BRIEF DESCRIPTION OF THE DRAWINGS

Other features and advantages of the present invention will become apparent in the following detailed description of the preferred embodiments with reference to the accompanying drawings, of which:

FIG. 1 is a block diagram showing the first preferred embodiment of an electronic watch according to the present invention;

FIG. 2 is a schematic diagram showing the first preferred embodiment with screen content thereof at an initial angular position;

FIG. 3 is a schematic diagram showing the first preferred embodiment with the screen content thereof rotated 10° in a first direction from the initial angular position;

FIG. 4 is a schematic diagram showing the first preferred embodiment with the screen content thereof rotated 20° in the first direction from the initial angular position;

FIG. 5 is a schematic diagram showing the first preferred embodiment with the screen content thereof rotated 30° in the first direction from the initial angular position;

FIG. 6 is a schematic diagram showing the second preferred embodiment of an electronic watch according to the present invention;

FIG. 7 is a schematic diagram showing a display angle menu on a display interface of the second preferred embodiment;

FIG. 8 is a schematic diagram showing the second preferred embodiment with screen content thereof rotated 30° in a first direction from an initial angular position;

FIG. 9 is a schematic diagram showing the third preferred embodiment of an electronic watch according to the present invention, a display interface of the electronic watch displaying a virtual rotary knob thereon; and

FIG. 10 is a schematic diagram showing the third preferred embodiment with screen content thereof rotated 90° in a first direction from an initial angular position.

### DETAILED DESCRIPTION OF THE PREFERRED EMBODIMENTS

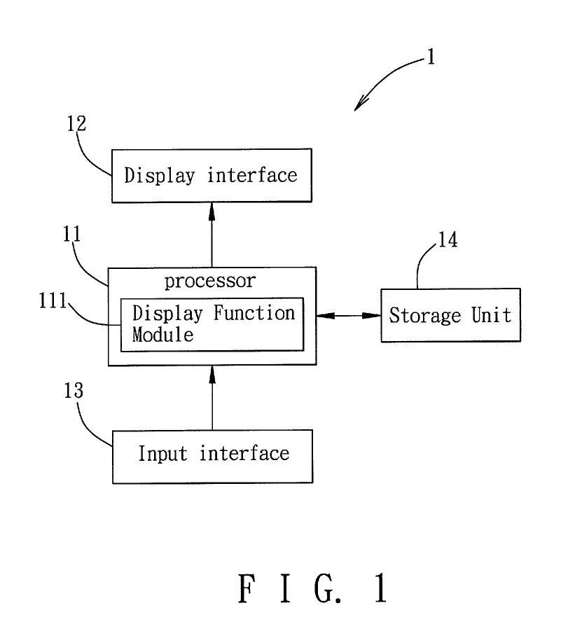

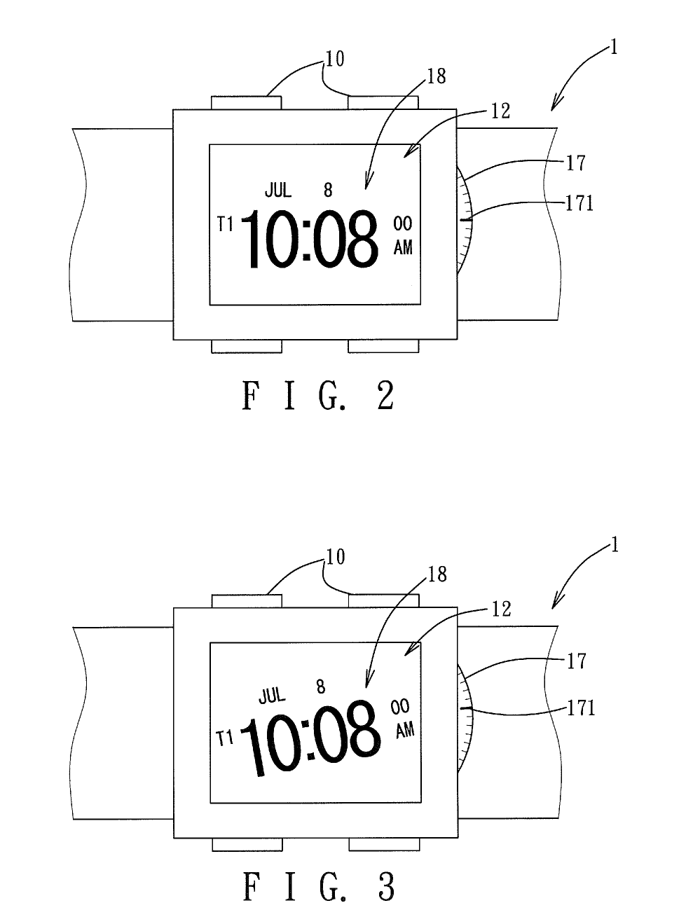

Referring to FIGS. 1 and 2, the first preferred embodiment of an electronic watch 1 according to the present invention includes a processor 11, a display interface 12, an input interface 13, and a storage unit 14.

The processor 11 includes a display function module 111 to generate screen content 18. The display function module 111 has at least two function modes, such as a time mode and a sports mode. In other embodiments, the display function module 111 has at least the time mode. Under the time mode, the display function module 111 generates the screen content 18 that is time related, such as current date and current time. Under the sports mode, the display function module 111 generates the screen content 18 that is sports related, such as heart rate, pulse rate, burned calories, mileage, number of steps, etc. Switching between the time mode and the sports mode may be accomplished by operating at least one press key 10 on a casing of the electronic watch 1.

The storage unit 14 is coupled electrically to the processor 11 and serves as a buffer for the screen content 18.

The display interface 12 is a liquid crystal display, is coupled electrically to the processor 11, and is operable to display the screen content 18.

The input interface 13 is coupled electrically to the processor 11, receives an input, and generates a setting command that corresponds to the input. The processor 11 is operable to determine a display angle corresponding to the setting command received from the input interface 13, and to rotate the screen content 18 according to the display angle thus determined. When the screen content 18 rotated by the processor 11 is displayed by the display interface 12, the screen content 18 is rotated relative to the display interface 12 by the display angle. Display of the screen content 18 is maintained with the setting of the display angle until the processor 11 determines a new display angle corresponding to a new setting command received from the input interface 13 under the angle setting mode. In this embodiment, the display angle ranges from 5° to 45° (i.e., ≧5° and ≦45°).

In this embodiment, the input interface 13 includes a rotary knob 17 disposed on the casing of the electronic watch 1. The rotary knob 17 has a rotation axis transverse to a display plane of the display interface 12. When the rotary knob 17 is rotated by a first angle in a first direction, the input interface 13 generates the setting command corresponding to rotation of the rotary knob 17, and the processor 11 rotates the screen content 18 in the first direction relative to the display interface 12 according to the display angle corresponding to the setting command. On the other hand, when the rotary knob 17 is rotated by a second angle in a second direction opposite to the first direction, the input interface 13 generates the setting command corresponding to rotation of the rotary knob 17, and the processor 11 rotates the screen content 18 in the second direction relative to the display interface 12 according to the display angle corresponding to the setting command.

In this embodiment, as shown in FIG. 2, the rotary knob 17 is formed with a plurality of graduations 171 each representing a unit angle. When the rotary knob 17 is at an initial position, a middle one of the graduations 171 extends in a horizontal direction, and the screen content 18 displayed by the display interface 12 is at an initial angular position, e.g., the screen content 18 is at a 0° angle relative to the display interface 12.

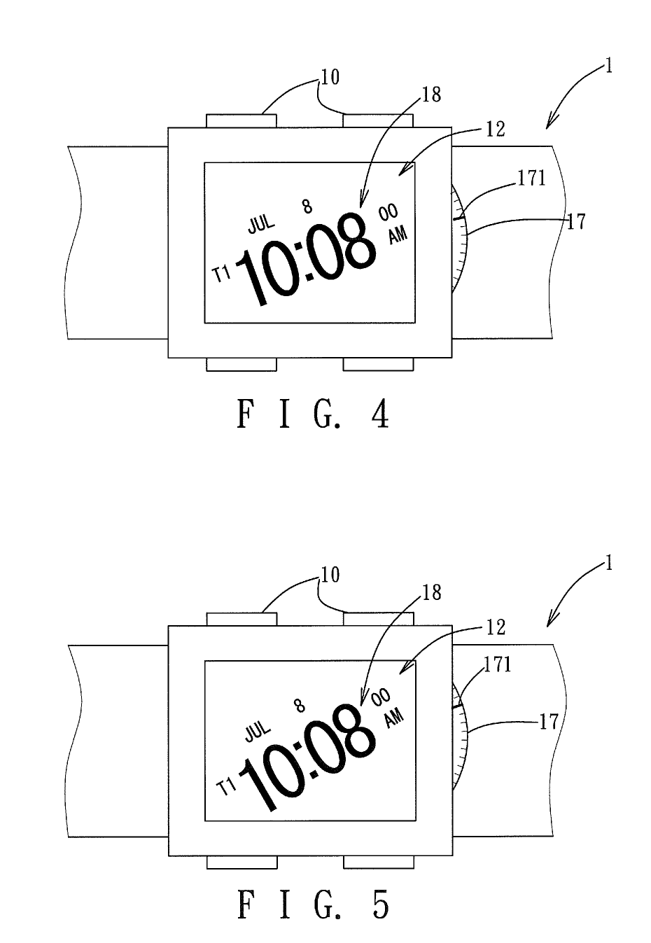

When the rotary knob 17 is rotated from the initial position by one graduation 171 in a first direction (e.g., in the counterclockwise direction), the input interface 13 outputs the corresponding setting command to the processor 11 . The processor 11 rotates the screen content 18 in the first direction by the unit angle according to the setting command such that the screen content 18 is rotated relative to the display interface 12 by the unit angle. Preferably, the unit angle ranges from 5° to 45° (i.e., ≧5° and ≦45°), and is more preferably one of 45°, 40°, 35°, 30°, 25°, 20°, 15°, 10°, and 5°. As shown in FIG. 3, in this embodiment, the unit angle of 10° is taken as an example. The screen content 18 is thus rotated relative to the display interface 12 by the unit angle of 10° in the first direction from the initial angular position. As shown in FIG. 4, when the rotary knob 17 is further rotated by one graduation 171 in the first direction, the input interface 13 outputs the corresponding setting command to the processor 11, and the processor 11 rotates the screen content 18 further in the first direction by the unit angle of 10° according to the setting command such that the screen content 18 is rotated relative to the display interface 12 by 20° in the first direction from the initial angular position. As shown in FIG. 5, further rotation of the rotary knob 17 by one graduation 171 in the first direction results in the screen content 18 being rotated relative to the display interface 12 by 30° in the first direction from the initial angular position.

Therefore, when the rotary knob 17 is rotated by one graduation 171 in a second direction (e.g., in the clockwise direction), the input interface 13 outputs the corresponding setting command to the processor 11, and the processor 11 rotates the screen content 18 in the first direction by the unit angle of 10° according to the setting command such that the screen content 18 is rotated relative to the display interface 12 by the unit angle of 10°. Accordingly, a user can operate the rotary knob 17 to control the processor 11 for adjusting display angle of the screen content 18, thereby achieving the effect of allowing the user to adjust the display angle of the screen content 18. Besides, multi-step adjustment of the display angle of the screen content 18 by the processor 11 is possible due to the graduations 171 on the rotary knob 17.

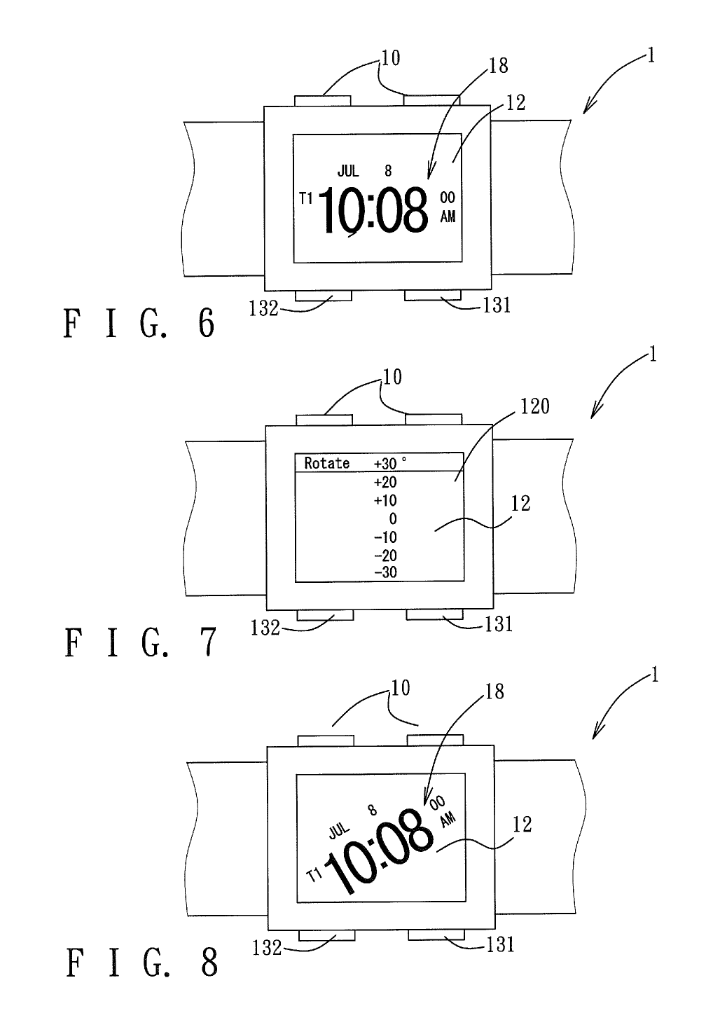

Referring FIG. 6 to FIG. 8, the second preferred embodiment of this invention differs from the first preferred embodiment in that the processor 11 is operable under an angle setting mode, in which the processor 11 controls the display interface 12 to display a display angle menu 120 thereon. As shown in FIG. 7, the display angle menu 120 contains a plurality of display angle options available for user selection. In this embodiment, the display angle options include angle 0° corresponding to an initial angular position, angles +10°, +20°, and +30° in the first (or counterclockwise) direction, and angles −10°, −20°, and −30° in the second (or clockwise) direction. Switching of the processor 11 to the angle setting mode may be accomplished by operating at least one press key 10 on the casing of the electronic watch 1. Furthermore, the storage unit 14 stores a look-up table shown in Table 1 below. The look-up table defines relations between preset setting commands (from A to G) and preset display angles (+30°, +20°, +10°, 0°, −10°, −20°, and −30°. Moreover, the input interface 13 includes at least one select button 131, 132 that is user operable to select one of the display angle options shown on the display interface 12 when the processor 11 is operated under the angle setting mode and to generate the setting command that corresponds to the selected one of the display angle options. Therefore, when the display angle option “+30°” is chosen by a user through the select buttons 131, 132, the processor 11 receives the setting command A that corresponds to the selected display angle option. The processor 11 then accesses the storage unit 14 to determine from the look-up table the display angle that corresponds to the setting command A received from the input interface 13 (which is +30° in the example), and to rotate the screen content 18 according to the display angle thus determined. Hence, the display interface 12 displays the screen content 18 adjusted by the processor 11 in a manner that the screen content 18 is rotated +30° from the initial angular position relative to the display interface 12, as shown in FIG. 8.

TABLE 1

| | |
|---|---|
| Setting command A | +30° |
| Setting command B | +20° |
| Setting command C | +10° |
| Setting command D | 0° |
| Setting command E | −10° |
| Setting command F | −20° |
| Setting command G | −30° |

Similarly, when the display angle option “−30° ” is chosen by the user through the select buttons 131, 132, the processor 11 receives the setting command G that corresponds to the selected display angle option. The processor 11 determines from the look-up table that the display angle corresponding to the setting command G is −30°, and adjusts the screen content 18 so that the screen content 18 is rotated −30° from the initial angular position relative to the display interface 12.

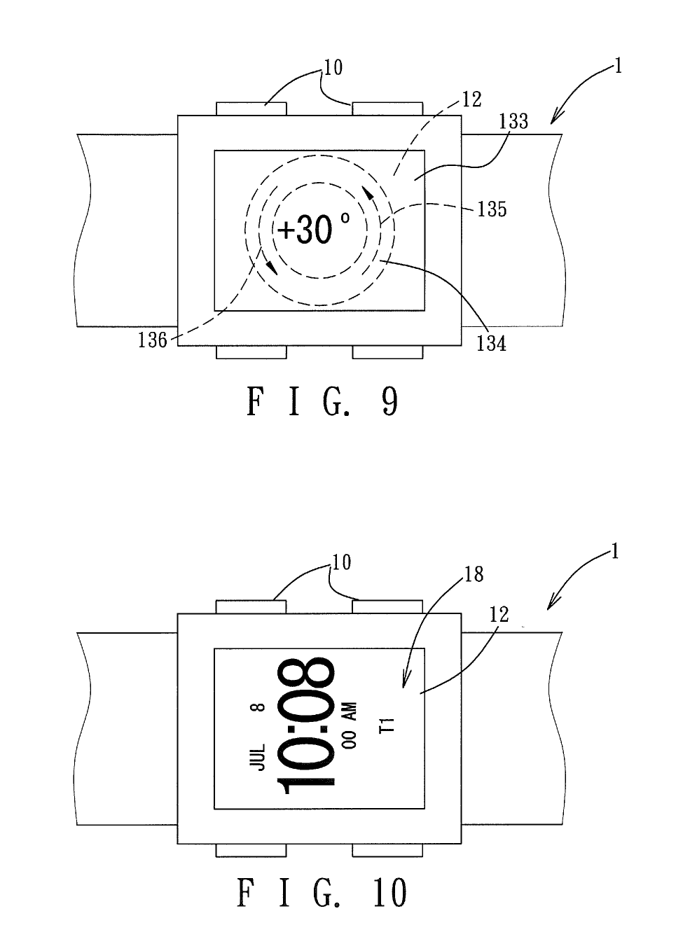

Like the previous embodiment, display of the screen content 18 is maintained with the last adjusted display angle until the processor 11 determines a new display angle corresponding to a new setting command received from the input interface 13. Referring FIG. 9, the third preferred embodiment of this invention differs from the first and second preferred embodiments in that the processor 11 controls the display interface 12 to display a virtual rotary knob 134 thereon when operated under the angle setting mode. Furthermore, the input interface 13 includes a transparent touch panel 133 that is disposed on the display interface 12 and that is operable to detect a gesture acting thereon. The function of the virtual rotary knob 134 is similar to the rotary knob 17 that is mentioned in the first preferred embodiment. When the processor 11 operates under the angle setting mode, the virtual rotary knob 134 is displayed on the display interface 12, and the processor 11 controls the display interface 12 to show a display angle option according to the gesture detected by the touch panel 133. The display angle option may be displayed around the virtual rotary knob 134 in other embodiments of the invention. The processor 11 recognizes the setting command corresponding to the gesture action that is detected at the position of the virtual rotary knob 134 displayed by the display interface 12, i.e., corresponding to the display angle option shown on the display interface 12 when the touch panel 133 no longer detects the gesture during operation of the processor 11 under the angle setting mode. The processor 11 subsequently rotates the screen content 18 according to the display angle option. As a result, the display interface 12 displays the screen content 18 rotated by the processor 11 in a manner that the screen content 18 is rotated from the initial angular position relative to the display interface 12 by the selected display angle. As an example, when the touch panel 133 detects an upward(counterclockwise) gesture 135 acting thereon, a display angle option (such as +30° in the example) is shown on the display interface 12 according to the upward (counterclockwise)gesture 135. When the upward(counterclockwise) gesture 135 is no longer detected by the touch panel 133 (that is, the display angle option on the display interface 12 is selected by the user), the processor 11 recognizes the setting command corresponding to +30° and rotates the screen content 18 by +30°. Hence, the display interface 12 displays the screen content 18 adjusted by the processor 11 in a manner that the screen content 18 is rotated by +30° from the initial angular position relative to the display interface 12 (see FIG. 8). Likewise, when the touch panel 133 detects a downward (clockwise) gesture 136 acting thereon, a display angle option is shown on the display interface 12 according to the downward (clockwise) gesture 136. When the downward (clockwise) gesture 136 is no longer detected by the touch panel 133 (that is, the display angle option on the display interface 12 is selected by the user), the processor 11 recognizes the setting command for the display angle option and rotates the screen content 18 according to the selected display angle option so that the screen content 18 displayed on the display interface 12 is rotated by the selected display angle from the initial angular position relative to the display interface 12. Like the previous embodiments, display of the screen content 18 is rotated and maintained with the display angle after the processor 11 exits or ceases to operate under the angle setting mode.

In a modification of the third preferred embodiment, the processor 11 does not control the display interface 12 to display the virtual rotary knob when operated under the angle setting mode. As long as the angle setting mode is entered, the processor 11 is able to determine the setting command corresponding to the gesture action that is detected on the touch panel 133, i.e., the display angle is determined according to trace and direction (clockwise or counterclockwise) of the gesture action that is detected on the touch panel 133.

Preferably, the processor 11 is further operable to adjust at least one of character display position and character size of the screen content 18 according to the display angle such that the screen content 18 adjusted by the processor 11 is displayed at a central area of a display plane of the display interface 12. FIG. 10 shows the screen content 18 rotated 90° in a first (counterclockwise) direction from an initial angular position. Screen information on left and right sides of the current time in the original screen content 18 (see FIG. 6) are moved in the adjusted screen content 18 of FIG. 10 to ensure that the adjusted screen content 18 does not exceed the display area of the display interface 12 and will not be unclear due to close proximity to borders of the display interface 12.

To sum up, the electronic watch 1 of the present invention allows a user to select a desired display angle of screen content 18 through a rotary knob 17, a display angle menu 120 or a virtual rotary knob 134, and a processor 11 of the electronic watch 1 rotates the screen content 18 according to a setting command from the rotary knob 17, the display angle menu 120 or the virtual rotary knob 120 so that, when the screen content 18 is displayed by a display interface 12, the screen content 18 is rotated relative to the display interface 12 by the display angle selected by the user. Display of the screen content 18 is rotated and is maintained with the display angle until the processor 11 determines a new display angle corresponding to a new setting command received from the input interface 13. Besides, multi-step adjustment of the display angle of the screen content 18 by the processor 11 is possible.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An electronic watch comprising:
an input interface for receiving an input and for generating a setting command that corresponds to the input;
a processor coupled electrically to said input interface and operable to generate screen content, to determine a display angle corresponding to the setting command received from said input interface, and to rotate the screen content according to the display angle thus determined; and
a display interface coupled electrically to said processor and operable to display the screen content received from said processor in a manner that the screen content is rotated relative to said display interface by the display angle;
wherein display of the screen content is rotated and is maintained with the display angle until said processor determines a new display angle corresponding to a new setting command received from said input interface.

2. The electronic watch as claimed in claim 1, wherein said input interface includes a rotary knob, said rotary knob having a rotation axis that is transverse to a display plane of said display interface,
wherein, when said rotary knob is rotated by a first angle in a first direction, said input interface generates the setting command corresponding to rotation of said rotary knob, and said processor rotates the screen content in the first direction according to the display angle corresponding to the setting command, and
wherein, when said rotary knob is rotated by a second angle in a second direction opposite to the first direction, said input interface generates the setting command corresponding to rotation of said rotary knob, and said processor rotates the screen content in the second direction according to the display angle corresponding to the setting command.

3. The electronic watch as claimed in claim 2, wherein said rotary knob is formed with a plurality of graduations, and wherein rotation of said rotary knob by one graduation in either of the first and second directions results in said processor rotating the screen content in the corresponding one of the first and second directions by a unit angle corresponding to one graduation.

4. The electronic watch as claimed in claim 1, further comprising a storage unit for storing a look-up table that defines relations between the setting command and the display angle, said processor being coupled electrically to said storage unit and accessing said storage unit to determine the display angle that corresponds to the setting command received from said input interface.

5. The electronic watch as claimed in claim 4, wherein said processor is operable under an angle setting mode, in which said processor controls said display interface to display a display angle menu thereon, said display angle menu containing a plurality of display angle options available for user selection,
said input interface includes at least one select button that is user operable to select one of the display angle options shown on said display interface when said processor is operated under the angle setting mode and to generate the setting command that corresponds to the selected one of the display angle options, and
said processor accesses said storage unit to determine from said look-up table the display angle that corresponds to the setting command received from said input interface and to rotate the screen content according to the display angle thus determined.

6. The electronic watch as claimed in claim 1, wherein said processor is operable under an angle setting mode, in which said processor controls said display interface to display a virtual rotary knob thereon,
said input interface includes a transparent touch panel that is disposed on said display interface and that is operable to detect a gesture action thereon,
said processor recognizes the setting command corresponding to the gesture action at the position of said virtual rotary knob displayed by said display interface, and
display of the screen content is rotated and is maintained with the display angle after said processor ceases to operate under the angle setting mode.

7. The electronic watch as claimed in claim 1, wherein said processor is operable under an angle setting mode,
said input interface includes a transparent touch panel that is disposed on said display interface and that is operable to detect a gesture action thereon,
said processor recognizes the setting command corresponding to the gesture action at the position of said transparent touch panel, and
display of the screen content is rotated and is maintained with the display angle after said processor ceases to operate under the angle setting mode.

8. The electronic watch as claimed in claim 1, wherein said processor is further operable to adjust at least one of character display position and character size of the screen content according to the display angle such that the screen content adjusted by said processor is displayed at a central area of a display plane of said display interface.
